(19) United States
(12) Patent Application Publication
(10) Pub. No.: US 2015/0305065 A1
(43) Pub. Date: Oct. 22, 2015

(54) RANDOM ACCESS PROCEDURE AND RELATED APPARATUS

(71) Applicant: BROADCOM CORPORATION, Irvine, CA (US)

(72) Inventors: Wei BAI, Beijing (CN); Jukka Tapio RANTA, Kaarina (FI); Pengfei SUN, Beijing (CN); Haiming WANG, Beijing (CN); Xinying GAO, Beijing (CN); Lili ZHANG, Beijing (CN); Jing HAN, Beijing (CN)

(73) Assignee: BROADCOM CORPORATION, Irvine, CA (US)

(21) Appl. No.: 14/435,872

(22) PCT Filed: Oct. 19, 2012
(86) PCT No.: PCT/CN2012/083233

§ 371 Date: Apr. 15, 2015

(51) Int. Cl. H04W 74/08; H04W 74/00

(52) U.S. Cl. CPC H04W 74/0833; H04W 74/002

(57) ABSTRACT

A new random access procedure is introduced that does not use a timing advance for the uplink timing but instead uses the downlink timing for uplink timing. This is particularly viable when the propagation delay is short, for example with local area cells having a coverage range less than some predetermined threshold. From the mobile terminal's perspective it obtains downlink timing for a cell, transmits a scheduling request SR in a contention-based uplink resource, and in response to receiving an uplink resource allocation it transmits in the allocated uplink resource using the downlink timing. The terminal can get the configuration for that contention-based uplink resource from system information. From the uplink resource the terminal and network determines a SR-RNTI, which the network uses to address the uplink resource allocation and the terminal uses to find a pre-defined search space in which to look for that uplink resource allocation.

### TECHNICAL FIELD

The exemplary and non-limiting embodiments of this invention relate generally to wireless communication systems, methods, devices and computer programs and, more specifically, relate to random access procedures particularly for cells with a relatively small coverage area.

### BACKGROUND

It is well documented that wireless traffic has undergone explosive growth in recent years, particularly with the widespread adoption of Internet-capable smart phones. It is widely accepted that this trend will continue. In recent years the increased traffic volume has been met by technological improvements in bandwidth utilization and network architecture. As to architecture, the use of smaller sized cells has proven quite effective; over the past 50 years it is anticipated that utilizing smaller network cells has enabled a capacity increase of 2700 times. Some reasons for this relate to shorter channel delays, smaller propagation delays, a fewer number of user equipments (UEs) being handled by a given network access node, and lower mobility speed requirements. In the Long Term Evolution (LTE) radio access technology this small cell concept falls within the category of local area (LA) networks, which improve over the more traditional macro cells for much the same reasons as listed above.

The inventors have found that these smaller cells can be further adapted for even greater throughput efficiencies by re-designing the random access (RA) procedure. In the current LTE system, the RA procedure is performed by UEs transmitting preambles in the Physical Random Access Channel (PRACH). The RA functions as an interface between non-synchronized UEs and the orthogonal transmission scheme of the LTE uplink radio access (for an overview, see for example Stefania Sesia, Issam Toufik, Matthew Baker, “LTE The UMTS Long Term Evolution-From Theory to Practice Second Edition,”). An important function of the RA procedure in LTE is to enable the UE's access to the network and synchronization of the UE's uplink (UL) transmission timing.

FIG. 1 is a signaling diagram illustrating a conventional contention-based RA procedure in the LTE system [Figure 10.1.5.1-1 of 3GPP TS 36.300 V11.3.0 (2012-09)]. Upon initial access to the network, the UE knows the existence of a serving access node (eNB) by downlink (DL) synchronization, but the eNB has no information of this new UE until the UE has successfully accessed the network. The UE randomly selects a preamble which it sends in message 1, looks for message 2 that has an uplink resource grant for the UE and then the UE uses that granted resource to send message 3. An important function of the RA procedure in this case is to provide opportunities for new UEs to transmit pre-defined preambles to the eNB at message 1 of FIG. 1 so the UEs can get synchronized to the UL and request a grant of UL resources (which are allocated at message 2 of FIG. 1) on which to send radio resource control (RRC) Connection Request signaling to the eNB (which is sent on the allocated resources at message 3 of FIG. 1). The LTE system utilizes single-carrier frequency-division multiple access (SC-FDMA) in the UL, meaning multiple UEs must align their UL transmissions in the time domain to avoid inter-symbol and inter-cell interference (ISI and ICI). For non-synchronized UEs, such as the new UE above or one experiencing radio link failure or a handover, the network can use the RA procedure to estimate the timing difference of these UE's UL transmission and then compensate the timing difference by sending a timing advance (TA) command back to the UE. That UE can then be UL synchronized after adjusting its local transmission timing using the TA.

Following are a few scenarios from 3GPP TS 36.213 v10.2.0 (2011-06) and TS 36.321 v10.5.0 (2012-03) which are relevant for a UE in the LTE system needing to use a RA procedure.
A UE in the RRC_CONNECTED state but not uplink-synchronized, and needing to send new uplink data or control information (such as for example an event-triggered measurement report);
A UE in the RRC_CONNECTED state but not uplink-synchronized, and needing to receive new downlink data will need UL synchronization to transmit the corresponding ACK/NACK (acknowledgement/negative acknowledgement) back to the network;
A UE in the RRC_CONNECTED state and handing over from its current serving cell to a target cell;
For positioning purposes in RRC_CONNECTED state, when a TA is needed for UE positioning;
A transition from the RRC_IDLE state to the RRC_CONNECTED state, for example for initial access or tracking area updates; and
Recovering from radio link failure.

These are exemplary but non-limiting scenarios in which these teachings concerning RA procedures can be used to advantage, whether in the LTE system or in other radio access technologies which utilize a RA procedure for a UE to synchronize with the network.

### SUMMARY

In a first exemplary aspect of the invention there is a method for operating a wireless network comprising: utilizing a first random access procedure to connect users to cells of a first type, wherein the first random access procedure provides to the users connecting to cells of the first type a timing advance for finding uplink timing from a known downlink timing and the first type is characterized by having a coverage range greater than a predetermined threshold; and utilizing a second random access procedure to connect users to cells of a second type, wherein the second random access procedure utilizes known downlink timing for the uplink timing and the second type is characterized by having a coverage range less than a predetermined threshold.

In a second exemplary aspect of the invention there is an apparatus for controlling a wireless network. This apparatus comprises a processing system which includes or otherwise comprises at least one processor and a memory storing a set of computer instructions. In this embodiment the at least one processor is arranged with the memory storing the instructions to cause the apparatus to: utilize a first random access procedure to connect users to cells of a first type, wherein the first random access procedure provides to the users connecting to cells of the first type a timing advance for finding uplink timing from a known downlink timing and the first type is characterized by having a coverage range greater than a predetermined threshold; and utilize a second random access procedure to connect users to cells of a second type, wherein the second random access procedure utilizes known downlink timing for the uplink timing and the second type is characterized by having a coverage range less than a predetermined threshold.

In a third exemplary aspect of the invention there is a computer readable memory tangibly storing a set of computer executable instructions comprising: code for utilizing a first random access procedure to connect users to cells of a first type, wherein the first random access procedure provides to the users connecting to cells of the first type a timing advance for finding uplink timing from a known downlink timing and the first type is characterized by having a coverage range greater than a predetermined threshold; and code for utilizing a second random access procedure to connect users to cells of a second type, wherein the second random access procedure utilizes known downlink timing for the uplink timing and the second type is characterized by having a coverage range less than a predetermined threshold.

In a fourth exemplary aspect of the invention there is a method for controlling a user equipment, comprising: obtaining downlink timing for a cell; transmitting a scheduling request in a contention-based uplink resource; and in response to receiving an uplink resource allocation, transmitting in the allocated uplink resource using the downlink timing.

In a fifth exemplary aspect of the invention there is an apparatus for controlling a user equipment, the apparatus comprising a processing system, in which the processing system includes or otherwise comprises at least one processor and a memory storing a set of computer instructions. In this embodiment the at least one processor is arranged with the memory storing the instructions to cause the apparatus to at least: obtain downlink timing for a cell; transmit a scheduling request in a contention-based uplink resource; and in response to receiving an uplink resource allocation, transmit in the allocated uplink resource using the downlink timing.

In a sixth exemplary aspect of the invention there is a computer readable memory tangibly storing a set of computer executable instructions comprising: code for obtaining downlink timing for a cell; transmitting a scheduling request in a contention-based uplink resource; and code for transmitting in an allocated uplink resource using the downlink timing in response to receiving the uplink resource allocation.

In a seventh exemplary aspect of the invention there is a method for controlling a network access node, comprising: determining a scheduling request temporary identifier from a contention-based uplink resource in which is received a scheduling request from a user equipment; and sending to the user equipment an uplink resource allocation addressed to the scheduling request temporary identifier within a search space that is pre-defined according to the scheduling request temporary identifier.

In a eighth exemplary aspect of the invention there is an apparatus for controlling a network access node, the apparatus comprising a processing system, in which the processing system includes or otherwise comprises at least one processor and a memory storing a set of computer instructions. In this embodiment the at least one processor is arranged with the memory storing the instructions to cause the apparatus to sat least: determine a scheduling request temporary identifier from a contention-based uplink resource in which is received a scheduling request from a user equipment; and send to the user equipment an uplink resource allocation addressed to the scheduling request temporary identifier within a search space that is pre-defined according to the scheduling request temporary identifier.

In a ninth exemplary aspect of the invention there is a computer readable memory tangibly storing a set of computer executable instructions comprising: code for determining a scheduling request temporary identifier from a contention-based uplink resource in which is received a scheduling request from a user equipment; and code for sending to the user equipment an uplink resource allocation addressed to the scheduling request temporary identifier within a search space that is pre-defined according to the scheduling request temporary identifier.

These and other embodiments and aspects are detailed below with particularity.

### BRIEF DESCRIPTION OF THE DRAWINGS:

FIG. 1 is a prior art signaling diagram reproducing Figure 10.1.5.1-1 of 3GPP TS 36.300 V11.3.0 (2012-09) and illustrating a contention-based RACH procedure according to conventional LTE specifications.

FIG. 2 illustrates timing for different transmissions by different UEs and shows that under certain conditions a user equipment that does not obtain uplink synchronization by means of a timing advance signaled by the network can still avoid ICI and ISI among those transmissions.

FIG. 3 is a bird's eye view of a macro eNB and a local area eNB and their respective coverage areas, and represent a non-limiting radio environment in which these teachings can be deployed to advantage.

FIG. 4 is a logic flow diagram that illustrates a method for operating a wireless network, and a result of execution by an apparatus of a set of computer program instructions embodied on a computer readable memory for operating such a network, in accordance with certain exemplary embodiments of this invention.

FIG. 5 is a signaling diagram for a random access procedure according to a non-limiting embodiment of these teachings.

FIG. 6 is an exemplary algorithm for pre-defining a search space from a scheduling request temporary identifier SR-RNTI according to a non-limiting embodiment of these teachings.

FIGS. 7-8 are logic flow diagrams that illustrate a method for controlling a respective user equipment and network access node, and a result of execution by an apparatus of a set of computer program instructions embodied on a computer readable memory for controlling such apparatus, in accordance with certain exemplary embodiments of this invention.

FIG. 9 is a simplified block diagram of a UE and an eNB which are exemplary electronic devices suitable for use in practicing the exemplary embodiments of the invention.

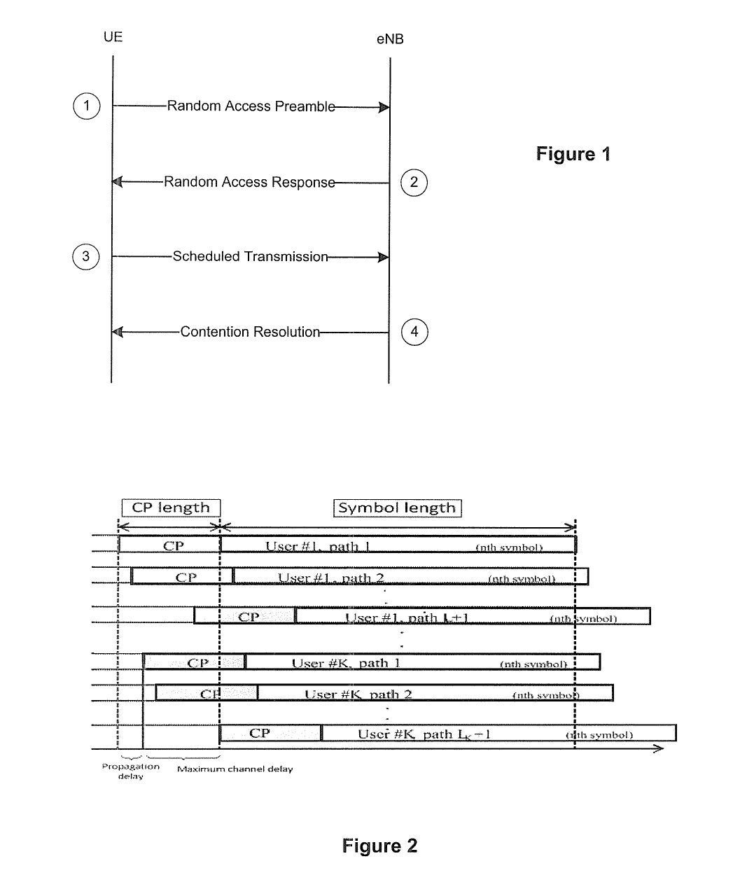

### DETAILED DESCRIPTION:

The RA procedures detailed herein are in the context of the LTE system but that is only by way of example; these teachings may be utilized in other radio access technologies whether the RA is used in more traditional networks having only one bandwidth, or in carrier aggregation deployments in which the UE might utilize an RA procedure on one component carrier according to these teachings to learn the relevant timing information for another component carrier of the same system.

Conventional RA procedures which are relevant for the LA scenario of the LTE system are first reviewed to give the reader a fuller understanding of the improvements and advantages offered by these teachings. In the UL transmission the propagation delay and multi-path effect can lead to significant misalignment between the UL transmissions from multiple UEs. Consider a simple example of two UEs, one close to the eNB and another far at the macro cell edge. Both transmit at precisely the same instant, but the different propagation delays and multi-path effects can result in the eNB receiving those two transmissions at different times. This can lead to significant inter-symbol-interference (ISI) and inter-cell-interference (ICI) after the eNB performs its discrete Fourier transform (DFT) detection.

One purpose of the RA procedure then is to allow the eNB to estimate the timing difference of each UE and adjust the transmission time in the UE's initial access stage. For example the random access response message (RAR, sometimes termed message 2 which gives the UE an UL resource allocation) contains a TA command (length 11-bits) that allows the eNB to compensate for up to 100 km cell radius. But the LA network cells are characterized in having a smaller cell size and therefore a shorter channel delay profile. It follows that the UL timing difference would be reduced, assuming the UEs have DL synchronization. For example, a cell radius of 200 m leads to only 1.3 μs round trip propagation delay. Since this is much smaller than the cyclic prefix (CP) length 4.7 μs currently used in LTE, as will be shown below these teachings provide a way to make the UL synchronization unnecessary in the LA scenario, leaving the cyclic prefix sufficient to handle the UL timing difference issue. Consider a more rigorous study; without the UL synchronization procedure the following equation must be satisfied to avoid causing any ISI and ICI:

Round_trip_propagation_delay+maximum_channel_delay<CP_length

FIG. 2 illustrates in principle that an ICI-free and ISI-free sampling window is possible. There are K users (UEs) each of whose transmissions to the eNB can follow one of L_{K}+1 possible paths. The propagation delay depends on the cell size, and the length of the CP is known from LTE specifications. Subtracting the propagation delay from the length of the CP gives the maximum channel delay as shown graphically underneath the “CP Length” column of FIG. 2. User #K and path L_{K}+1 is just beyond the maximum possible delay. Taking a quantitative analysis using the WINNER channel model as shown in Table 1 below as the basic channel model for the LA network, the maximum channel delay is up to 487 ns in the B4 scenario outdoor-to-indoor. This means that for a typical LTE CP length 4.7 μs, the system could support ICI-free and ISI-free UL detection with cell radius, without the conventional UL synchronization procedure.

TABLE 1
WINNER channel model maximum delay:

| | Environment description | | | | | |
|---|---|---|---|---|---|---|
| | Indoor (office: | | indoor (large hall: | | Indoor-to- | Outdoor-to- |
| | corridor/room) | | lecture/industrial) | | outdoor | indoor |
| | Channel model indicator | | | | | |
| | A1 | | B3 | | A2 | B4 |
| Line-Of-Sight (LOS) vs. Non-LOS | LOS | NLOS | LOS | NLOS | not specified | not specified |
| Max. excess delay 50%/90% fractals | 180/377 | 146/252 | 125/175 | 175/250 | 175/362 | 239/487 |
| [ns] | | | | | | |

The above analysis proves that, from the interference avoidance point of view, the conventional UL synchronization may not be necessary in a LA network as it is in a macro LTE system. Stated another way, in such a LA network the UE may perform an UL transmission at any time when it is DL is synchronized. But as noted particularly above, one main function of the conventional RA procedure is to perform UL synchronization. Since this function may not be needed in LA networks, the teachings below detail how to simplify the whole RA procedure for LA networks in order to achieve enhanced efficiency.

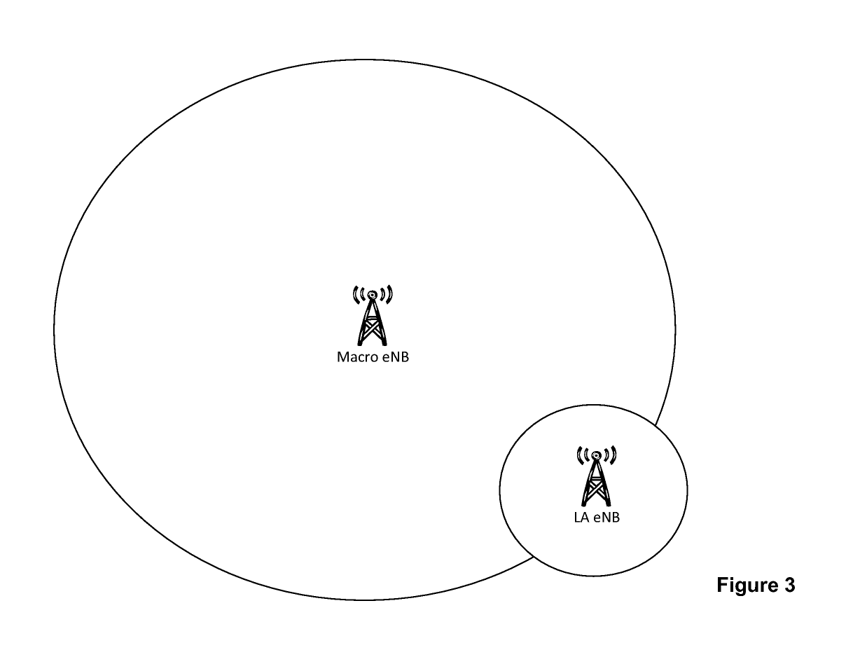

FIG. 3 is a conceptual layout of a macro eNB and a local area eNB as one non-limiting deployment for these teachings. The circle about which each eNB is centered represents the geographic extent of the cell boundaries for that eNB. The macro and LA cell are shown as partially overlapping but in other deployments the LA cell may be wholly within the bounds of the macro cell, or completely outside those bounds.

According to exemplary embodiments of these teachings detailed more fully below, there is a new RA procedure for use in LA cells, different from the RA procedure used in the larger macro cells. In effect this new RA procedure utilizes a simplified UL synchronization procedure in that it combines DL synchronization and UL synchronization to one status. In an embodiment of this new RA procedure there is also adaption between a separated RA channel and a shared scheduling request (SR) and RA channel. There is a contention-based SR for RA, there is a temporary identifier termed a SR-RNTI which is determined from the resource on which the UE sends its SR, and the handover procedure is also simplified.

The specific example set forth below assumes that, as proved by the quantitative review of FIG. 2, for the LA scenario the UL transmission timing could be based on the DL synchronization, and the CP length is sufficiently long to prevent any ISI and ICI arising due to the timing differences of multiple UEs where those timing differences arise from the lack of a TA provided by the network as in conventional RA procedures.

Consider again the macro and LA cells in FIG. 3. The LA cell range is small enough that its propagation delay at the cell edge (the largest possible propagation delay) is less than a threshold, where such a threshold is shown under the “CP length” column of FIG. 2 and computed above for the B4 scenario of the WINNER channel model. Having met that criteria, the LA cell can choose to configure a contention based physical uplink control channel (PUCCH) for scheduling requests, rather than the conventional PRACH that the macro eNB configures. The UE can know which RA procedure is in use in either cell by checking system information block 2 (SIB-2); there the macro cell will configure the PRACH and the LA cell will configure the PUCCH for SR.

When the target coverage is bigger than the range which UE could transmit without TA as with the macro cell shown at FIG. 2, the (macro) eNB could still configure PRACH in SIB-2 and utilize the conventional RA procedures. For convenience term these conventional RA procedures a first RA procedure for cells of a first type, where the first type is characterized in having a coverage range greater than a predetermined threshold (greater than a cutoff propagation delay, which might in practice be implied from maximum transmit power or some other metric used as a proxy for propagation delay or cell range).

When the target coverage is smaller than the threshold/range the (LA) cell is allowed to remove the TA mechanism and the LA eNB can just configure a contention based PUCCH (SR) in SIB-2. For convenience term the new RA procedures that do not provide a TA to the users as a second RA procedure for cells of a second type, where the second type is characterized in having a coverage range less than the predetermined threshold, The LA cell reserves the contention based PUCCH (SR) resource from the normal SR to avoid possible collisions. In a more specific embodiment the contention based SR could be grouped in order to indicate to the LA eNB about the different size of Message 3, as will be detailed further below. In short, for this second RA procedure message 3 will carry user data, rather than the user's RRC Connection Request as in the first/conventional RA procedure. This is possible because the user will have the UL synchronization already before it sends message 3 in the second/new RA procedure whereas the user gets the TA and its UL synchronization from the network only in the network's response to message 3 in the second/conventional RA procedure.

While the example above uses a contention based PUCCH (SR), in practice there is no reason this PUCCH for SR must be so restricted, so in certain deployments the LA eNB can use it for both contention based and non-contention based RA purposes. Note also that in the deployment of FIG. 2 each eNB will configure only one of the RA channels noted above; either the PUCCH (SR) as stated for the LA cell using the new/second RA procedure, or the PRACH as stated above for the macro cell using the conventional/first RA procedure.

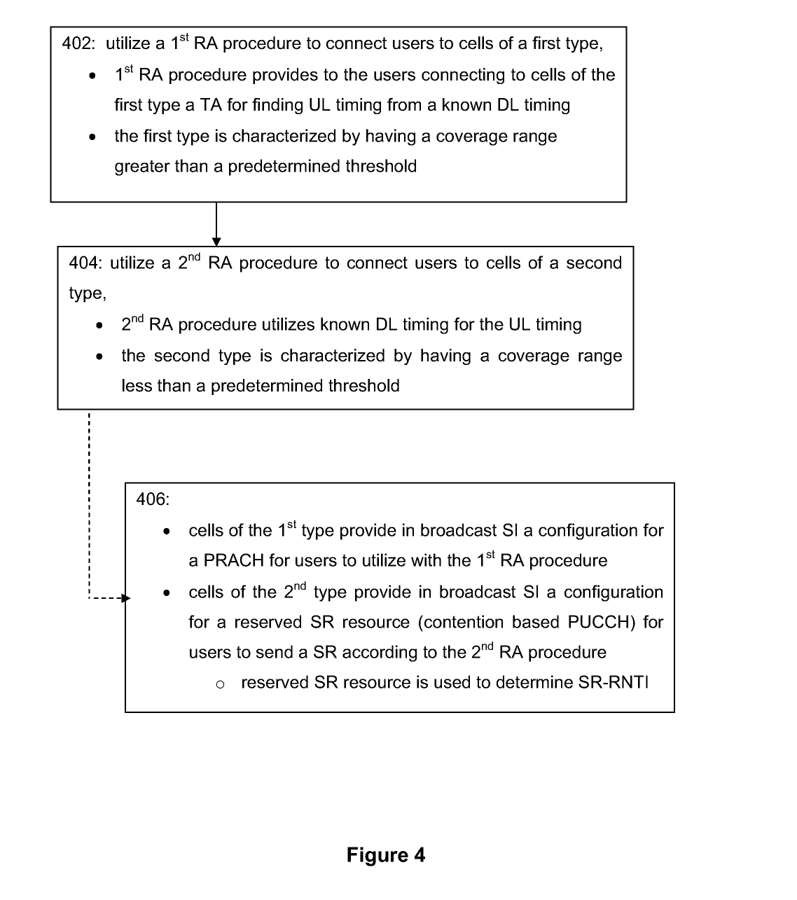

Before detailing further specifics of this new RA procedure, FIG. 4 summarizes the above aspects from the perspective of the operator of the network which has both the macro eNB and the LA eNB. Block 402 describes that the network operator runs the network such that a first random access procedure is utilized to connect users to cells of a first type, where the first random access procedure provides to the users connecting to cells of the first type a timing advance for finding uplink timing from a known downlink timing and the first type is characterized in having a coverage range greater than a predetermined threshold. At block 404 the network operator also runs the network such that a second random access procedure is utilized to connect users to cells of a second type, where the second random access procedure utilizes known downlink timing for the uplink timing and the second type is characterized in having a coverage range less than a predetermined threshold.

Block 402 tells that the first RA procedure provides to the users connecting to cells of the first type a TA for finding uplink timing from known downlink timing. This is the conventional RA procedure for LTE systems; the UE gets downlink timing from network signaling it receives (such as broadcast system information) and gets a TA in dedicated signaling from the network during the conventional/first RA procedure. The UE adjusts that known DL timing in the amount of the TA to get its UL timing for its own transmissions to that macro cell, which is a cell of the first type. For the second RA procedure block 404 tells that it utilizes known downlink timing for the uplink timing. That is, there is no TA adjustment to the DL timing, and as explained above with respect to FIG. 2 using the DL timing as the UL timing is acceptable for LA cells (those that meet the coverage range criteria at block 404) because the short propagation delay assures there will be no undue ICI or ISI with other UE's transmissions.

Block 406 summarizes a non-limiting aspect of the invention and details how the cells in the above example ‘advertise’ to the UEs which type of cell they are, or more particularly which RA procedures they are running. Specifically, cells of the first type (macro cells) are characterized by providing, in broadcast system information (SIB-5), a configuration for a PRACH for users to utilize with the first RA procedure. Similarly, cells of the second type (LA cells) are characterized by providing, in broadcast system information (also SIB-5), a configuration for a reserved scheduling request resource (the contention-based PUCCH for SR) for users to send a SR according to the second RA procedure. While not specified in the FIG. 4 summary, above it was detailed that the second RA procedure comprises using the reserved SR resource to determine a SR-RNTI, and that SR-RNTI is used to distinguish which user is granted an uplink radio resource since the network addresses the UL resource grant to the SR-RNTI.

As detailed more fully above, the predetermined threshold of blocks 402 and 404 may in some embodiments be determined from at least propagation delay, and also both the first and second RA procedures are contention-based, though as noted at least the PUCCH-SR used in the second RA procedure can also be used for a contention-free RA procedure.

The above examples detail that the new RA procedure can exist in the LA cells of a network alongside the conventional RA procedures whereby the macro cells provide a TA to the accessing UE for the UE's UL synchronization. Now are detailed some further particulars for that new RA procedure according to some non-limiting deployments of it.

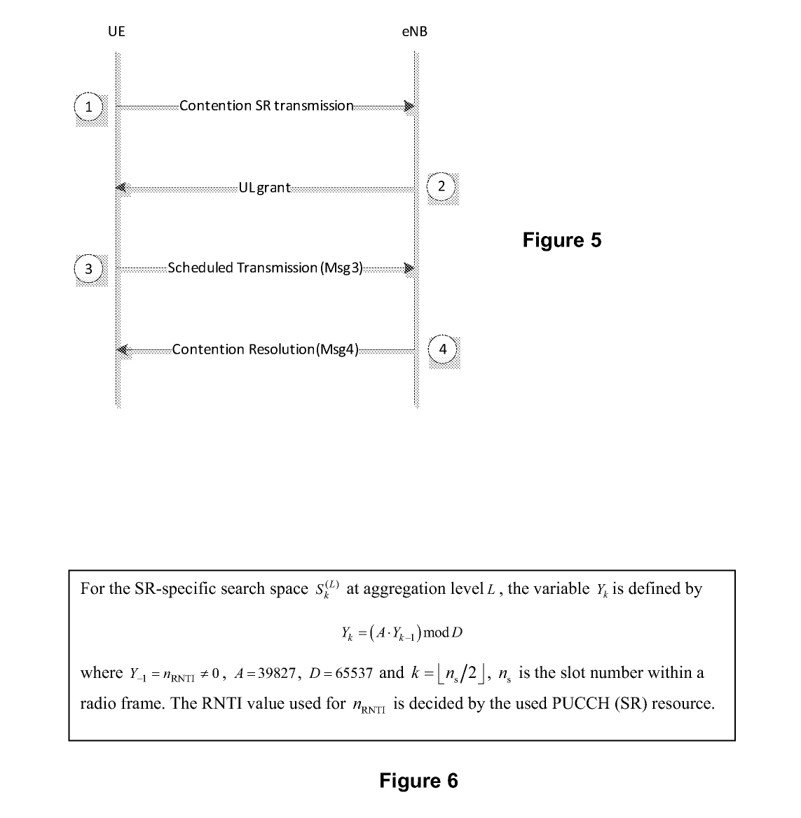

The UE is initially not in a RRC connected state with the cell; it may be just powering on or it may have lost a connection that it seeks to re-establish. Firstly the UE needs to get the downlink synchronization for the cell, which it does by listening to the cell's broadcast system information (SI). By decoding this SI block the UE also learns the cell's configuration for the physical uplink control channel for scheduling requests (PUCCH-SR), which replaces the PRACH for this new RA procedure. In this case the UE's access will be contention-based, so it selects a resource in that PUCCH-SP on which to transmit its scheduling request uplink to the cell. This is shown as message 1 at FIG. 5, which is a signaling diagram for this new RA procedure. Note that in an embodiment of these teachings, the UE does not send the SR-RNTI in the message 1 of FIG. 5; the first time the SR-RNTI is signaled is by the LA eNB in message 2 of FIG. 5. Both the LA eNB and the UE calculate what is the SR-RNTI from the uplink resource that the UE used to send message 1; the LA eNB addresses message 2 to the SR-RNTI and the UE uses the SR-RNTI to find whether there is some message 2 which grants the UE an uplink resource. As detailed below, the UE also uses the SR-RNTI to know the search space in which to look for some message 2 that is addressed to that same SR-RNTI.

The LA eNB then detects the UE's scheduling request in the PUCCH-SR resource, and from that same uplink resource it detected the LA eNB determines what SR-RNTI is associated with it. This might be considered a mapping between the PUCCH-SR resource and a unique SR-RNTI. Now having the SR-ANTI, there is also associated with that SR-RNTI a pre-defined search space and the LA eNB sends its allocation of an uplink resource to the UE, which is shown as message 2 at FIG. 5. In the LTE system this allocation is a physical downlink control channel PDCCH, and so the UE knows this allocation is for it the allocation is addressed to the SR-RNTI. So through the SR-RNTI, the PDCCH maps back to the uplink resource the UE used for message 1.

Back on the UE side, it was the UE that selected the particular PUCCH-SR resource on which to send message I, and so the UE also determines the SR-RNTI from that resource it selected and then looks up in its memory the pre-defined search space associated with that SR-RNTI. The UE then blindly detects in that search space for a PDCCH addressed to the SR-RNTI, and finds message 2 from the LA eNB. An implementation of how to implement this search space aspect of these teachings is detailed further below. The search space is preferably distributed so that poor channel conditions in one frequency sub-band will not frustrate the whole RA procedure. Message 2 is the UE's uplink resource allocation which the UE has now detected within the pre-defined search space, and thereafter the UE simply sends message 3 as shown in FIG. 5 using its SR-RNTI to scramble any re-transmissions (assuming hybrid automatic repeat-request HARQ is supported in the LA cell).

After receiving message 3 from the UE on the granted uplink resource, and assuming the UE's contention resolution succeeds, the network replies with message 4 which gives a conventional cell-radio network temporary identifier (C-RNTI) to replace the SR-RNTI for further communications between the UE and the LA eNB. This also differs from the conventional RA procedure which has the eNB sending a temporary C-RNTI (T-C-RNTI) to the UE, and promoting that temporary C-RNTI to a regular/permanent C-RNTI if the contention resolution identifier in message 3 matches the identifier in message 4. In these teachings there is no temporary C-RNTI needed and the eNB will send the final C-RNTI in message 4, so it is not necessary for the UE to check for a match. In one specific but non-limiting embodiment the eNB's reply/message 4 that replaces the SR-RNTI is a C-RNTI medium access control element MAC CE that allocates the C-RNTI value for future scheduling of the user equipment.

In the conventional RA procedure the random access response message (message 2) is addressed with the random access radio network temporary identifier (RA-RNTI) to indicate which PRACH resource is detected. In this new RA procedure the contention is done in the PUCCH-SR channel, and so some further detail is in order to define how to indicate which contention based SR resource is detected in the message 2 of FIG. 5, which is in the new RA procedure a PDCCH giving an uplink grant to the UE. The skilled reader will recognize several ways to do so, but in one implementation PUCCH resource indexing is used for this purpose. For example, there may be a relation known to both the UE and the LA eNB by which:

SR-RNTI=t_{id}+10×n_{PUCCH}^{c};

where: t_{id} is the subframe number of the SR that the UE selected and used in message 1; and n_{PUCCH}^{C} is the contention-based SR resource index within each subframe.

This is just one way in which the SR-RNTI will unambiguously link to each SR resource. The UE will get the configuration of the PUCCH-SR channel from decoding the LA eNB's SI, but the specific contention-based PUCCH-SR resource on which the UE sends its message 1 is in an embodiment randomly selected by the UE.

The volume of wireless traffic being what it is, one concern for many RA schemes is the resource capacity. This directly determines how many signatures could be supported to do the RA procedure at the same time, and thus influences how many UEs can utilize the RA scheme. The conventional LTE protocol supports 64 signatures with an allocation of 6 physical resource blocks (PRBs). In one exemplary deployment of this new RA procedure each PRB supports at maximum 12 resources, from code domain spreading with 3 times time domain spreading and assuming the maximum offset Δ_{shift}^{PUCCH}=12 is selected. This selection is reasonable for the new RA procedure because the offset is determined by the maximum channel delay spread, which is very small as detailed above with respect to FIG. 2. This means that 36 signatures could be supported in each PRB and 2 PRBs will support more than the required 64 signatures (assuming 64 will be required if this new RA procedure is adopted in future versions of LTE). The LA eNB can then flexibly configure the RA resource using a smaller RA resource granularity, such as in units of 2 PRBs instead of units of 6 PRBs.

With the signature capacity and RA resource configuration resolved we now turn to further detailing the pre-defined search space which is linked to the SR-RNTI and within which the UE limits its blind detection to find the PDCCH in message 2. In the conventional RA procedure for LTE, all the random access response (message 2) on the same PRACH resource are multiplexed together and addressed by only one PDCCH which lies in a common search space. In an example but non-limiting implementation of this new RA procedure, such multiplexing is not used and so it would not be advantageous to also put the PDCCHs addressed to the different SR-RNTIs in any common search space. It is for this reason that the search space is pre-defined per SR-RNTI, leaving each search space to be UE-specific rather than common.

The skilled reader will recognize there are many options to implement a pre-defined search space linked to a specific SR-RNTI (or other such identifier). FIG. 6 presents one non-limiting example of how to do so. Both the UE and the LA eNB will have such a formula in their local memory for finding or otherwise mapping the search space from the SR-RNTI, or the formula may equivalently be implemented in their local memory as a look-up table entered using the SR-RNTI that is linked to the PUCCH-SR resource used for message 1. The given values for the constants A and D are specific for the channel protocols of the LTE system and so will change when these teachings are adapted for implementation in another radio access technology, or as the protocols for LTE may change in the future. The index k represents a given UE, and RNTI in FIG. 6 refers to the SR-RNTI from the above examples.

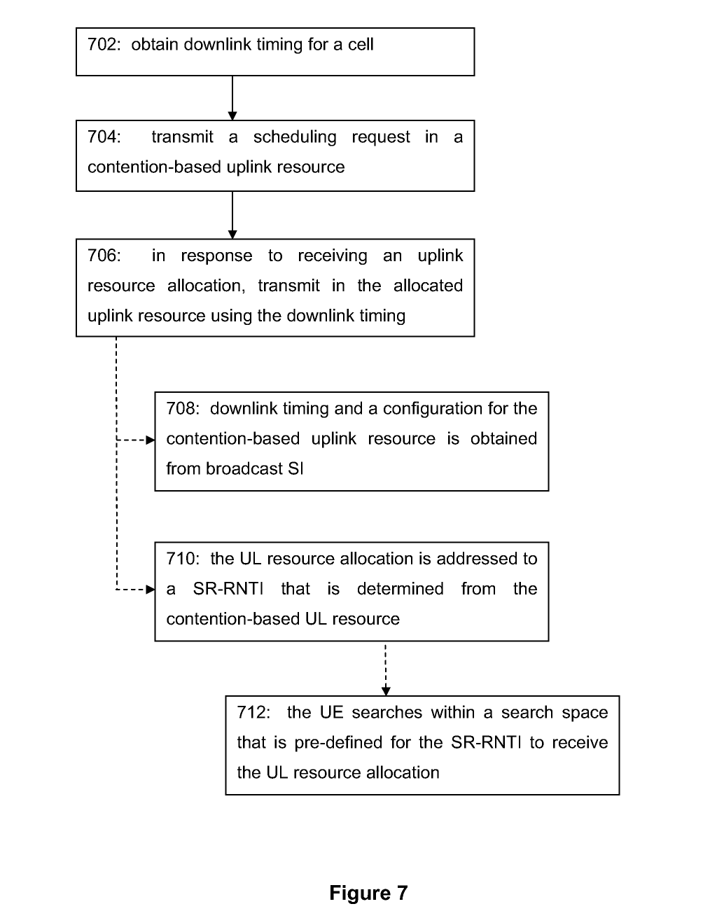

FIG. 7 presents a summary of the above teachings for the new RA procedure from the perspective of the UE. At block 702 the UE obtains downlink timing for a cell, then at block 704 it transmits a scheduling request in a contention-based uplink resource, and finally at block 706, in response to receiving an uplink resource allocation, the UE transmits in the allocated uplink resource using the downlink timing.

Some of the non-limiting implementations detailed above are also summarized at FIG. 7 as indicated by the dashed lines. Block 708 specifies that the downlink timing mentioned at block 702, as well as a configuration for the contention-based uplink resource (PUCCH-SR) is obtained from broadcast system information. In other non-limiting embodiments the UE can learn the downlink timing from some other downlink signaling, such as for example a downlink synchronization signal or a reference signal. Block 710 notes that the uplink resource allocation received at block 706 (the PDCCH) is addressed to a scheduling request temporary identifier (SR-RNTI) that is determined from the contention-based uplink resource. And block 712 summarizes that receiving the block 706 uplink resource allocation comprises the UE searching within a search space that is pre-defined for the scheduling request temporary identifier (SR-RNTI). Not repeated at FIG. 7, above it was noted that the LIE can transmit user data in the uplink resource that was allocated at block 706 using the downlink timing that was obtained in block 702.

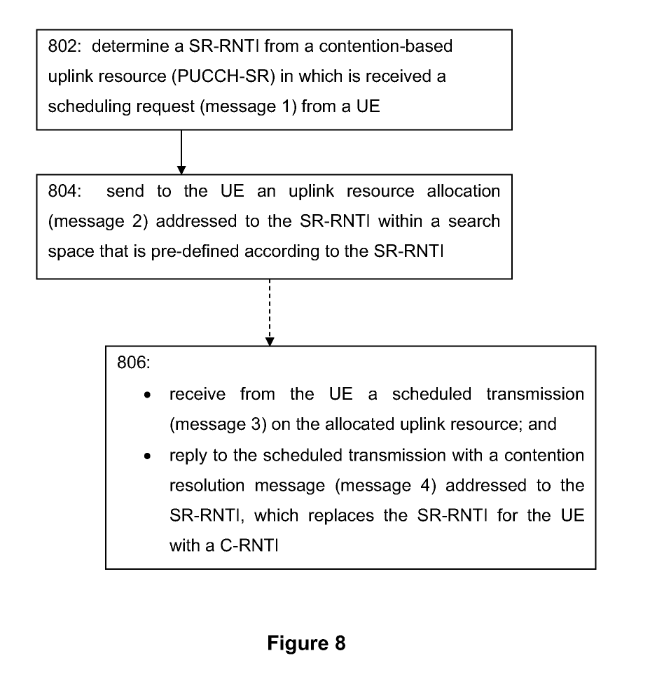

FIG. 8 is a summary of the above teachings for the new RA procedure from the perspective of the eNB or other access node, whether a LA eNB or otherwise. Block 802 finds the eNB determining a scheduling request temporary identifier (SR-RNTI) from a contention-based uplink resource (PUCCH-SR) in which is received a scheduling request (message 1) from a UE, and then at block 804 the eNB sends to the UE an uplink resource allocation (PDCCH, message 2) addressed to the scheduling request temporary identifier, and the eNB sends it within a search space that is pre-defined according to the scheduling request temporary identifier. To complete the summary from the eNB's perspective are the further (non-limiting) steps at block 806 of the eNB receiving from the UE a scheduled transmission (on a physical uplink shared channel PUSCH, message 3) on the allocated uplink resource; and replying to the scheduled transmission with a contention resolution message (message 4) addressed to the scheduling request temporary identifier. In this case the contention resolution message replaces the SR-RNTI for the user equipment with a C-RNTI.

With the above understanding of the new RA procedure, now consider the case of a UE moving from a serving cell to a target cell using in a handover procedure. If the target cell is small enough (see the discussion of FIG. 2), the UE does not need to get a timing advance for the target cell and thus the handover process can be simplified as compared to conventional practice. Specifically, the serving cell can include inn its handover command to the UE an uplink grant, which the serving cell coordinates with the target cell. The UE then simply transmits a RRC Connection Reconfiguration Complete message to the target cell on that allocated uplink resource.

The handover process may be considered as a special case of a contention free random access procedure which the UE performs with the target cell before being handed over. In this simplified handover the UE gets downlink timing of the target cell as normal, and like the new contention-based RA procedure above it can assume it is synchronized with that target cell in the UL using the DL timing the UE obtained for the target cell. As detailed above, this is reasonable since the maximum propagation delay is below the threshold in a LA cell, which would avoid ICI/ISI. In the conventional handover procedure the serving cell forwards to the UE a contention free random access resource so the UE can obtain the target cell's timing advance without having to contend with other UEs which use a random preamble. With this simplified handover procedure the serving cell forwards an uplink resource allocation to the UE so the UE can, using its assumed UL timing for the target cell, quickly initiate an uplink transmission to the target cell without performing any random access procedures.

Embodiments of these teachings provide one or more of the following technical effects, particularly when implemented in LA networks as compared to traditional macro eNBs/cells. There is a simplified UL control channel which utilizes a shared SR and a 0PUCCH channel design. Some embodiments enable better granularity options for the random access purpose, for example the eNB could choose to use only one PRB to support up to 36 contention resources, or use two PRBs to support up to 72 contention resources. This provides a possibility to increase the capacity of the random access as compared to legacy LTE protocols. Additionally, this simplified RA procedure avoids transmitting the random access response (message 2) in a PDSCH. The UE will not need to find the UL grant in the DL packet, which could reduce the latency of the RA procedure. And finally there is also a simplified handover procedure, which also reduces the handover latency

The logic diagrams of FIGS. 4 and 7-8 may be considered to illustrate the operation of a method, and a result of execution of a computer program stored in a computer readable memory, and a specific manner in which components of an electronic device are configured to cause that electronic device to operate, whether such an electronic device is the UE or eNB or mobility management entity (AIME), or one or more components thereof such as a modem, chipset, or the like. The various blocks shown in FIGS. 4 and 7-8 may also be considered as a plurality of coupled logic circuit elements constructed to carry out the associated function(s), or specific result of strings of computer program code or instructions stored in a memory.

Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Such circuit/circuitry embodiments include any of the following: (a) hardware-only circuit implementations (such as implementations in only analog and/or digital circuitry) and (b) combinations of circuits and software (and/or firmware), such as: (i) a combination of processor(s) or (ii) portions of processor(s)/software (including digital signal processor(s)), software, and memory(ies) that work together to cause an apparatus, such as a mobile phone/UE, to perform the various functions summarized at FIGS. 4 and 7-8 and (c) circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” also covers, for example, a baseband integrated circuit or applications processor integrated circuit for a mobile phone/LTE or a similar integrated circuit in a server, a cellular network device, or other network device which operates according to these teachings.

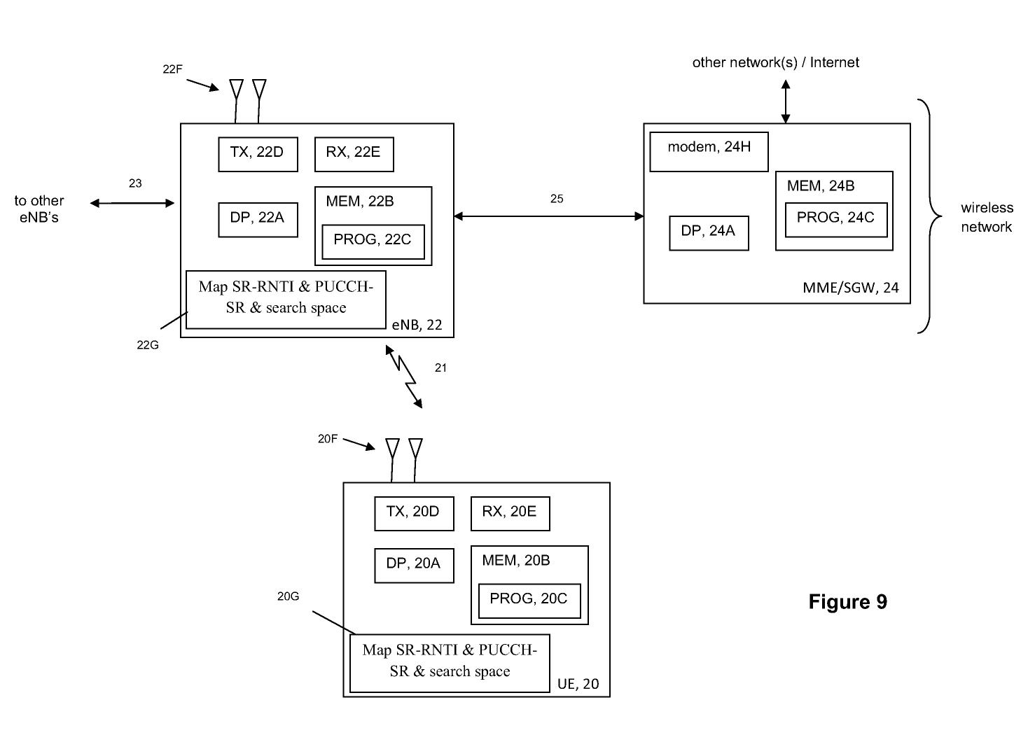

Reference is now made to FIG. 9 for illustrating a simplified block diagram of various electronic devices and apparatus that are suitable for use in practicing the exemplary embodiments of this invention. In FIG. 9 an eNB 22 is adapted for communication over a wireless link 21 with an apparatus, such as a mobile terminal or UE 20. The eNB 22 may be any access node (including frequency selective repeaters) of any wireless network using licensed (and in some embodiments also unlicensed) bands, such as LTE, LTE-A, GSM, GERAN, WCDMA, and the like. The operator network of which the eNB 22 is a part may also include a network control element such as a mobility management entity MME and/or serving gateway SGW 24 or radio network controller RNC which provides connectivity with further networks (e.g., a publicly switched telephone network PSTN and/or a data communications network/Internet).

The UE 20 includes processing means such as at least one data processor (DP) 20A, storing means such as at least one computer-readable memory (MEM) 20B storing at least one computer program (PROG) 20C, communicating means such as a transmitter TX 20D and a receiver RX 20E for bidirectional wireless communications with the eNB 22 via one or more antennas 20F. Also stored in the MEM 20B at reference number 20G are the algorithms or look-up tables by which the UE 20 can determine the SR-RNTI from the PUCCH-SR and the search space from the SR-RNTI as variously described in the embodiments above. This unit 20G also informs the UE when it can use a cell's downlink timing as its uplink timing, such as when it sees the cell's SI configuring a PUCCH-SR rather than a PRACH.

The eNB 22 also includes processing means such as at least one data processor (DP) 22A, storing means such as at least one computer-readable memory (MEM) 22B storing at least one computer program (PROG) 22C, and communicating means such as a transmitter TX 22D and a receiver RX 22E for bidirectional wireless communications with the UE 20 via one or more antennas 22F. The eNB 22 stores at block 22G similar mappings/algorithms/look-up tables for moving between PUCCH-SR, SR-RNTI, and search space as detailed above for the UE at block 20G.

While not particularly illustrated for the UE 20 or eNB 22, those devices are also assumed to include as part of their wireless communicating means a modem and/or a chipset which may or may not be inbuilt onto an RF front end chip within those devices 20, 22 and which also operates utilizing rules for assuming the UL timing and the SR-RNTI/PUCCH-SR/search space mapping as set forth in detail above.

At least one of the PROGs 20C in the UE 20 is assumed to include a set of program instructions that, when executed by the associated DP 20A, enable the device to operate in accordance with the exemplary embodiments of this invention, as detailed above. The eNB 22 also has software stored in its MEM 22B to implement certain aspects of these teachings. In these regards the exemplary embodiments of this invention may be implemented at least in part by computer software stored on the MEM 20B, 22B which is executable by the DP 20A of the UE 20 and/or by the DP 22A of the eNB 22, or by hardware, or by a combination of tangibly stored software and hardware (and tangibly stored firmware). Electronic devices implementing these aspects of the invention need not be the entire devices as depicted at FIG. 9 or may be one or more components of same such as the above described tangibly stored software, hardware, firmware and DP, or a system on a chip SOC or an application specific integrated circuit ASIC.

In general, the various embodiments of the UE 20 can include, but are not limited to personal portable digital devices having wireless communication capabilities, including but not limited to cellular telephones, navigation devices, laptop/palmtop/tablet computers, digital cameras and music devices, and Internet appliances.

Various embodiments of the computer readable MEMs 20B, 22B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A, 22A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the LTE and LTE-A systems, as noted above the exemplary embodiments of this invention are not limited for use with only this one particular type of wireless communication system.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. A method for operating a wireless network, comprising:
utilizing a first random access procedure to connect users to cells of a first type, wherein the first random access procedure provides to the users connecting to cells of the first type a timing advance for finding uplink timing from a known downlink timing and the first type is characterized by having a coverage range greater than a predetermined threshold; and
utilizing a second random access procedure to connect users to cells of a second type, wherein the second random access procedure utilizes known downlink timing for the uplink timing and the second type is characterized by having a coverage range less than a predetermined threshold.

2. The method according to claim 1, wherein the predetermined threshold is determined from at least propagation delay.

3. The method according to claim 1, wherein both the first random access procedure and the second random access procedure are contention-based.

4. The method according to claim 1, wherein:
cells of the first type are characterized in providing, in broadcast system information, a configuration for a physical random access channel for users to utilize with the first random access procedure; and
cells of the second type are characterized in providing, in broadcast system information, a configuration for a reserved scheduling request resource for users to send a scheduling request according to the second random access procedure.

5. The method according to claim 4, wherein the second random access procedure comprises using the reserved scheduling request resource to determine a scheduling request radio network temporary identifier (SR-RNTI) which is used to distinguish which user is granted an uplink radio resource.

6. The method according to claim 1, wherein any given cell is configurable to utilize either of the first and the second random access procedures based on the coverage range of the given cell.

7. The method according to claim 1, wherein the second random access procedure is characterized by an uplink scheduling request which is sent uplink using the known downlink timing and no offset therefrom.

8. An apparatus for controlling a wireless network, the apparatus comprising a processing system which comprises at least one processor and a memory storing a set of computer instructions;
wherein the processing system is configured to cause the apparatus at least to:
utilize a first random access procedure to connect users to cells of a first type, wherein the first random access procedure provides to the users connecting to cells of the first type a timing advance for finding uplink timing from a known downlink timing and the first type is characterized by having a coverage range greater than a predetermined threshold; and
utilize a second random access procedure to connect users to cells of a second type, wherein the second random access procedure utilizes known downlink timing for the uplink timing and the second type is characterized by having a coverage range less than a predetermined threshold.

9. The apparatus according to claim 8, wherein the predetermined threshold is determined from at least propagation delay.

10. The apparatus according to claim 8, wherein both the first random access procedure and the second random access procedure are contention-based.

11. The apparatus according to claim 8, wherein:
cells of the first type are characterized in providing, in broadcast system information, a configuration for a physical random access channel for users to utilize with the first random access procedure; and
cells of the second type are characterized in providing, in broadcast system information, a configuration for a reserved scheduling request resource for users to send a scheduling request according to the second random access procedure.

12. The apparatus according to claim 11, wherein the second random access procedure comprises using the reserved scheduling request resource to determine a scheduling request radio network temporary identifier (SR-R TI) which is used to distinguish which user is granted an uplink radio resource.

13. The apparatus according to claim 8, wherein any given cell is configurable to utilize either of the first and the second random access procedures based on the coverage range of the given cell.

14. The apparatus according to claim 8, wherein the second random access procedure is characterized by an uplink scheduling request which is sent uplink using the known downlink timing and no offset therefrom.

15. A computer readable memory tangibly storing a set of computer executable instructions comprising:
code for utilizing a first random access procedure to connect users to cells of a first type, wherein the first random access procedure provides to the users connecting to cells of the first type a timing advance for finding uplink timing from a known downlink timing and the first type is characterized by having a coverage range greater than a predetermined threshold; and
code for utilizing a second random access procedure to connect users to cells of a second type, wherein the second random access procedure utilizes known downlink timing for the uplink timing and the second type is characterized by having a coverage range less than a predetermined threshold.

16. The computer readable memory according to claim 15, wherein the predetermined threshold is determined from at least propagation delay.

17. The computer readable memory according to claim 15, wherein both the first random access procedure and the second random access procedure are contention-based.

18. The computer readable memory according to claim 15, wherein: cells of the first type are characterized in providing, in broadcast system information, a configuration for a physical random access channel for users to utilize with the first random access procedure; and
cells of the second type are characterized in providing, in broadcast system information, a configuration for a reserved scheduling request resource for users to send a scheduling request according to the second random access procedure.

19. The computer readable memory according to claim 18, wherein the second random access procedure comprises using the reserved scheduling request resource to determine a scheduling request radio network temporary identifier (SR-RNTI) which is used to distinguish which user is granted an uplink radio resource.

20. The computer readable memory according to claim 15, wherein any given cell is configurable to utilize either of the first and the second random access procedures based on the coverage range of the given cell.

21-45. (canceled)
